(19) United States
(12) Patent Application Publication
(10) Pub. No.: US 2012/0279836 A1
(43) Pub. Date: Nov. 8, 2012

(54) SWITCH ARRANGEMENT, SYSTEM & DEVICE

(75) Inventors: Patrik Lundell, Svedala (SE); Martin Wolff, Lund (SE)

(73) Assignee: SONY MOBILE COMMUNICATIONS AB, Lund (SE)

(21) Appl. No.: 13/435,274

(22) Filed: Mar. 30, 2012

Related U.S. Application Data
(60) Provisional application No. 61/481,762, filed on May 3, 2011.

(30) Foreign Application Priority Data
May 2, 2011 (EP) 11164476.1

(51) Int. Cl. H01H 9/00

(52) U.S. Cl. 200/1 B

(57) ABSTRACT

Switch arrangement (18) that comprises a plunger member (22) that is arranged to be displaced between a first position and a second position. The plunger member (22) is arranged to establish electrical contact in a first transmission line (A-D) in said first position and to establish electrical contact in a second transmission line (A-C) in a second position, whereby the displacement of said plunger member (22) is arranged to break electrical contact with said first transmission line (A-D) while said plunger member (22) is being displaced from said first position into said second position, and to break electrical contact with said second transmission line (A-C) while said plunger member (22) is being displaced from said second position into said first position.

### RELATED APPLICATIONS

This application claims priority based on European Patent Application No. 11164476.1 filed May 2, 2011 and U.S. Provisional Patent Application No. 61/481,762 filed May 3, 2011, the disclosures of which are incorporated by reference herein their entirety.

### TECHNICAL FIELD

The present invention concerns a switch arrangement and a system, and a device, such as a communication device, comprising such a switch arrangement and/or system

### BACKGROUND OF THE INVENTION

In the field of electronics, impedance matching is the practice of designing the input impedance of an electrical load or the output impedance of its corresponding signal source in order to maximize power transfer and minimize reflections from the load.

Almost all mobile telephony system requirements in the original Group System for Mobile Communications (GSM) specification were specified for the conducted performance of a system so impedance matching has only conventionally been carried out for the conducted mode. However, as GSM technology develops and Long Term Evolution (LTE) is being introduced, more frequency bands need to be supported and matching circuits will have to be optimized to cover all frequency bands for both the conducted and the radiated performance of the systems in order to be able to transmit signals more efficiently.

In order to optimize a matching circuit of a system taking both the conducted performance and the radiated performance of the system into consideration, a switch is needed to switch between a first position whereby the conducted performance of the system may be determined, and a second position whereby the radiated performance of the system may be determined.

### SUMMARY OF THE INVENTION

An object of the invention is to provide a switch arrangement in a device, such as a communication device, which switch arrangement is suitable for antenna matching, for example for Long Term Evolution (LTE) and similar systems.

This object is achieved by a switch arrangement that is operated by a plunger member that is arranged to be displaced between a first position and a second position. The plunger member is arranged to establish electrical contact in a first transmission line in the first position and to establish electrical contact in a second transmission line in a second position. The displacement of the electrically conducting probe is arranged to break electrical contact with the first transmission line while the electrically conducting probe is being displaced from the first position into the second position, and to break electrical contact with the second transmission line while the electrically conducting probe is being displaced from the second position into the first position.

According to an other embodiment of the invention said electrically conducting probe comprises an electrically conducting probe or an external antenna connector.

According to an embodiment of the invention the switch arrangement is a coaxial switch arrangement for switching in coaxial transmission lines.

According to a further embodiment of the invention the switch arrangement is a double pole double throw switch arrangement.

According to an embodiment of the invention the electrical contact in the first transmission line is arranged to be established at the same time as electrical contact in the second transmission line is arranged to be broken, and the electrical contact in the second transmission line is arranged to be established at the same time as electrical contact in the first transmission line is arranged to be broken, i.e. the establishment of electrical contact in one transmission line occurs at the same time, or at substantially at the same time as electrical contact in the other transmission line is broken.

According to another embodiment of the invention the plunger member is resiliently-loaded, e.g. spring loaded, in order to absorb tolerances.

According to a further embodiment of the invention the dielectric isolator is mounted on the plunger member, i.e. the dielectric isolator may be arranged to be displaced together with the plunger member.

The present invention also concerns a system comprising an antenna, an antenna matching network, an amplifier of a radio frequency (RF) module, a matching circuit and a switch arrangement according to any of the embodiments of the invention for selectively connecting the amplifier to test apparatus or another antenna via the matching circuit when in a first position, and to the antenna via the antenna matching network when it is in a second position.

Such a system will enable the optimization of the matching circuit taking both the radiated performance of the system (i.e. when the switch is in the first position) and the conducted performance of the system (i.e. when the switch is in the second position) into consideration and will consequently result in the system being able to transmit signals more efficiently when in use. Such a system is particularly suitable for use in LTE-technology applications. It also provides a simple switch that may be used for optimizing the system prior to use and for connecting system components when the system is in use.

According to an embodiment of the invention the system comprises additional dual matching circuitry.

According to another embodiment of the invention at least part of the switch is arranged as a module on a substrate that is arranged to be connected between the amplifier and the antenna. The substrate may comprise dielectric material or ceramic material, such as low temperature co-fired ceramic (LTCC). The substrate may comprise a printed circuit board comprising one or more electric circuits or electronic components, an antenna matching network, an antenna or test apparatus.

The present invention further concerns a device that comprises a switch and/or a system according to any of the embodiments of the invention.

According to an embodiment of the invention the device comprises or constitutes a communication device such as a mobile telephone, media player, Personal Communications System (PCS) terminal, Personal Data Assistant (PDA), laptop computer, palmtop receiver, camera, television, radar, navigation device, such as a GPS device, or any appliance that includes a transducer designed to transmit and/or receive radio, television, telephone and/or radar signals.

### BRIEF DESCRIPTION OF THE DRAWINGS

The present invention will hereinafter be further explained by means of non-limiting examples with reference to the appended schematic figures where;

FIG. 1 shows a system according to an embodiment of the present invention with a switch in a first position,

FIG. 2 shows the system illustrated in FIG. 1 with the switch in a second position,

FIG. 3 shows a switch according to an embodiment of the present invention in a first position,

FIG. 4 shows a switch according to an embodiment of the present invention in a second position,

FIG. 5 shows a system according to an embodiment of the present invention with a switch in a first position,

FIG. 6 shows the system illustrated in FIG. 5 with the switch in a second position, and

FIG. 7 shows a device according to an embodiment of the present invention.

It should be noted that the drawings have not necessarily been drawn to scale and that the dimensions of certain features may have been exaggerated for the sake of clarity.

### DETAILED DESCRIPTION OF EMBODIMENTS

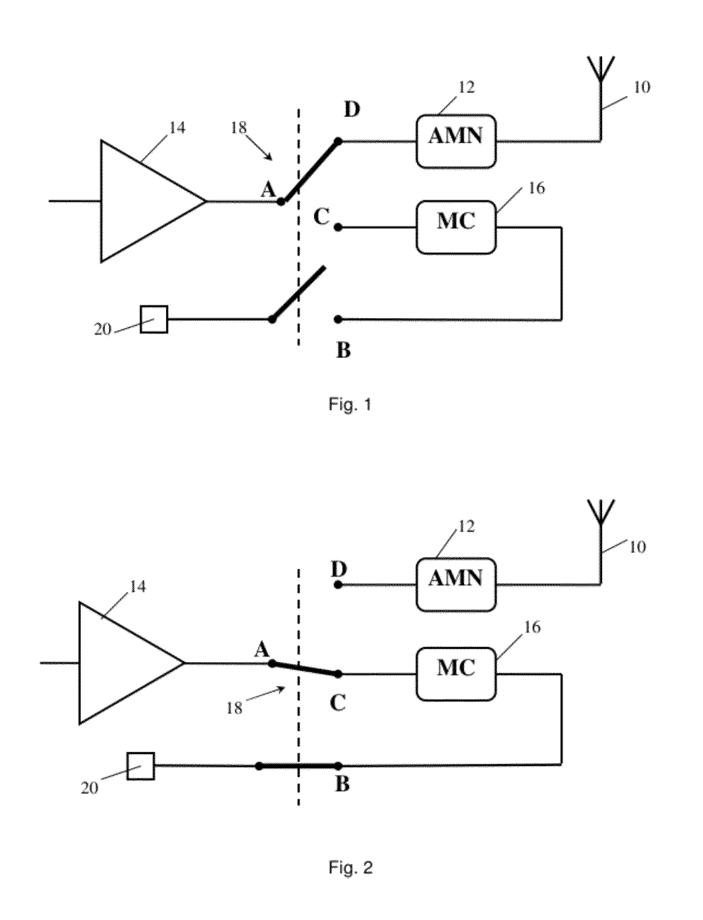

FIG. 1 shows a system according to an embodiment of the invention which comprises an antenna 10, an antenna matching network (AMN) 12, a power amplifier of a radio frequency (RF) module 14, a matching circuit (MC) 16, and a double pole double throw switch 18 in a first position in which electrical contact between two electrical contact points A and D is made. When the switch 18 is in this first position the amplifier 14 will be connected to the antenna 10 via the antenna matching network 12 and the radiative performance of the system can thereby be measured.

FIG. 2 shows the system illustrated in FIG. 1 when the double pole double throw switch 18 is in a second position in which electrical contact between electrical contact points A and C is made. During optimization of the matching circuit 16 the switch 18 is configured to connect the amplifier 14 to test apparatus 20 via the matching circuit 16. The antenna 10 and antenna matching network 12 are thereby disconnected and the conductive performance of the system can be measured.

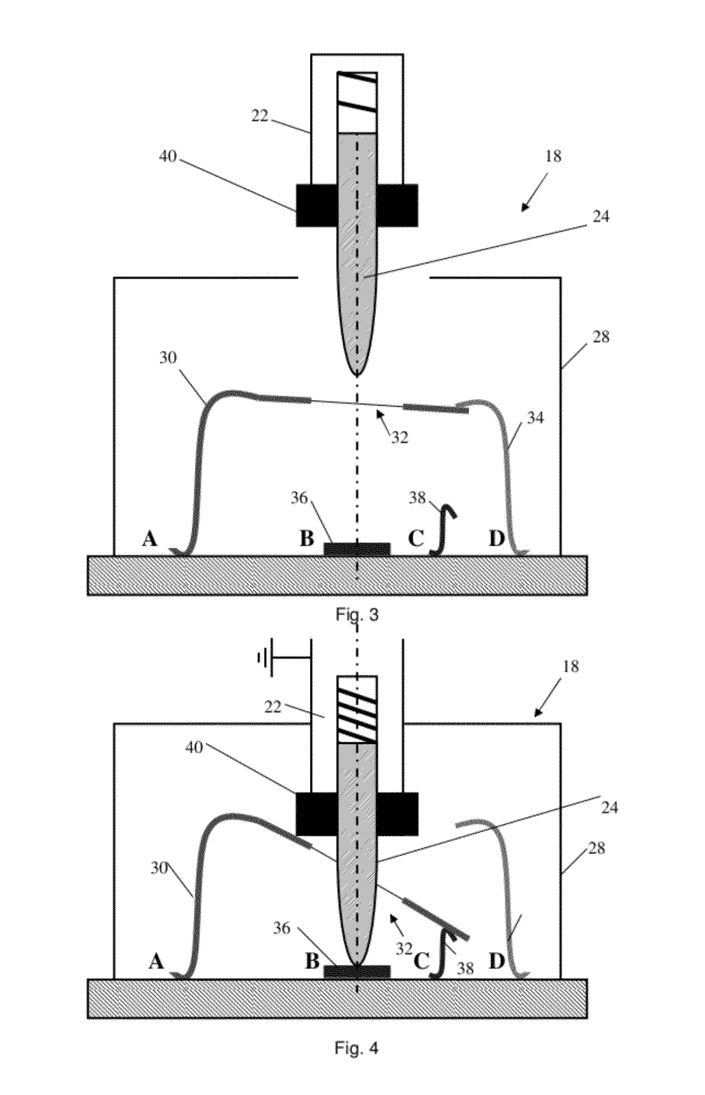

FIG. 3 shows a switch 18 according to an embodiment of the invention in a first position, or “normal mode” and FIG. 4 shows the switch in a second position or “engaged mode”. The switch 18 comprises a plunger member 22 that is arranged to be displaced between a first position (shown in FIG. 1) in which electrical contact between contact points A and D is made, and a second position (shown in FIG. 2) in which contact between contact points A and C is made.

The switch 18 is operated by a spring-loaded electrically conducting probe 24 or external antenna connector of the plunger member 22 which may be of any suitable size and shape and a dielectric isolator 40, which in the illustrated embodiment is mounted in the plunger member 22. The dielectric isolator 40 may however comprise of one or more dielectric isolators arranged so as to be displaced as a result of the displacement of the plunger member 22.

The dashed line in FIGS. 1 and 2 is intended to indicate that the switches of switch 18 are integrated and move simultaneously from the first position shown in FIG. 1 to the second position shown in FIG. 2.

In a first transmission line in the first position/normal mode (shown in FIG. 3) the switch is connecting terminals 30 and 34, i.e. the transmission line comprising contacts A and D, which may for example transmit signals between a frequency (RF) module 14 to an antenna via an antenna matching network (AMN) 12 as shown in FIG. 1. In the first position/normal mode, the electrically conducting probe 24 or external antenna connector is located outside the switch housing 28 whereby terminal 30 (a flexible electrical conductor comprising a hole 32 through which the electrically conducting probe 24 or external antenna connector may be inserted) makes contact with terminal 34, consequently establishing electrical contact between contacts A and D.

The plunger member 22 may be arranged to establish electrical contact in a second transmission line in its second position/engaged mode (shown in FIG. 4), i.e. the transmission line comprising contacts A and C and a second transmission line from the electrically conducting probe 24 or external antenna connector to B, separately from A to C, which may for example transmit signals between a test apparatus 20 and a frequency

(RF) module 14 via a matching circuit (MC) 16 as shown in FIG. 2. In order to become located in the second position/engaged mode the electrically conducting probe 24 or external antenna connector of the plunger member 22 must be displaced vertically downwards through the hole 32 in terminal 30 until it makes contact with a pad 36 which thereby establishes electrical contact between contacts A and C and B. When the electrically conducting probe 24 or external antenna connector is in the second position the dielectric isolator 40 pushes down on terminal 30 causing electrical contact between terminals 30 and 34 (and thereby between contacts A and D) to be broken.

It should be noted that the dielectric isolator 40 may be mounted on a terminal 30, the plunger member 22 or the electrically conducting probe 24 or external antenna connector may be arranged to cause the dielectric isolator 40 to break electrical contact between terminals 30 and 34 (and thereby between contacts A and D) as the plunger member 22/electrically conducting probe 24 or external antenna connector is displaced vertically downwards from its first position to its second position. In order to again become located in the first position (shown in FIG. 1) the plunger member 22/electrically conducting probe 24 or external antenna connector may be removed whereupon terminal A will lose contact with terminal 38 and re-establish contact with terminal 34.

The displacement of the electrically conducting probe 24, external antenna connector and/or plunger member 22 is therefore arranged to break electrical contact with a first transmission line (A-D) while the electrically conducting probe 24, or external antenna connector and/or plunger member 22 is being displaced from the first position into the second position, and to break electrical contact with the second transmission line (A-C) while the electrically conducting probe 24, or external antenna connector and/or plunger member 22 is being displaced from the second position into the first position, whereby electrical contact is established in one transmission line at the same time at which it is broken in the other transmission line.

The terminals 30, 34, 38 and pad 36 of the illustrated embodiment may be arranged on a circuit board within a device for example. According to an embodiment of the invention the entire switch 18 may be provided as an insertable and (optionally) removable module on a substrate, such as a low temperature co-fired ceramic (LTCC) substrate, which may be arranged to be connected between an amplifier 14 and an antenna matching network 12. The substrate 32 may be arranged to comprise at least part of a switch 18 of a system according to any of the embodiments of the invention. The substrate 32 may even be arranged to comprise an antenna matching network 12, an antenna 10, test apparatus 20, and/or any other electric components or electrical circuits.

It should be noted that the switch 18 of a system according to any of the embodiments of the invention may comprise a coaxial switch so that it may be connected to the coaxial cable of a test apparatus 20 and/or to a coaxial cable of a system comprising an antenna, an antenna matching network, an amplifier of a radio frequency (RF) module and a matching circuit for example.

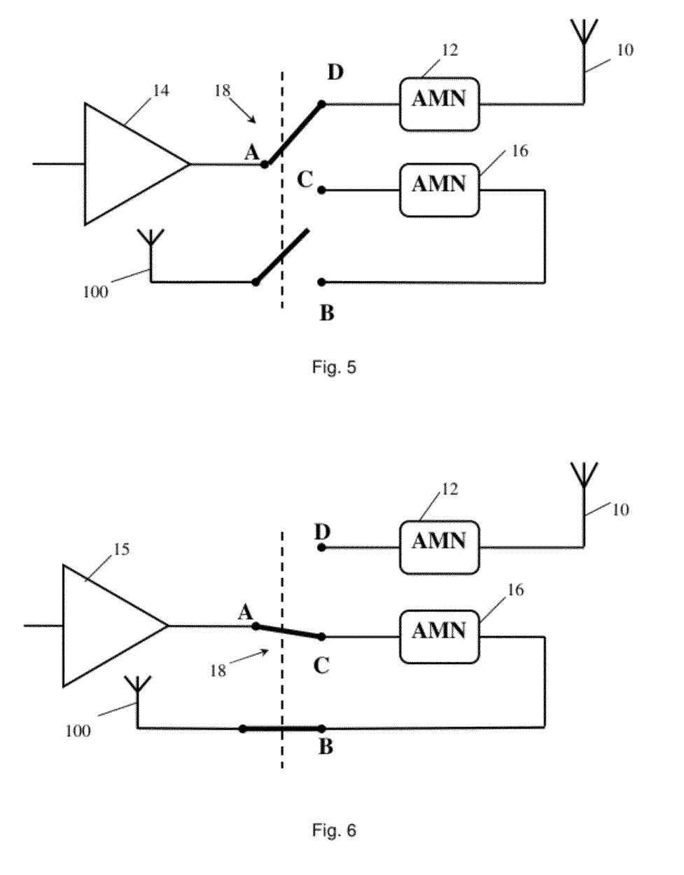

FIG. 5 shows a system according to another embodiment of the invention which enables the optimization of two antennas 10,100. The system comprises a first antenna 10, a first antenna matching network (AMN) 12, a power amplifier of a radio frequency (RF) module 14, a second antenna matching network (MC) 13, and a double pole double throw switch 18 in a first position in which electrical contact between two electrical contact points A and D is made. When the switch 18 is in this first position the amplifier 14 will be connected to the first antenna 10 via the antenna matching network 12 and the radiative performance of the system can thereby be measured.

FIG. 6 shows the system illustrated in FIG. 1 when the double pole double throw switch 18 is in a second position in which electrical contact between electrical contact points A and C is made. The switch 18 is configured to connect the amplifier 14 to a second antenna 100 via the second antenna matching network 13. The first antenna 10 and antenna matching network 12 are thereby disconnected and the radiative performance of the system comprising the second antenna 100 can thereby be measured.

The first and second antennas 10 and 100 may be an internal antenna (10) of a device and an external antenna (100) located externally to the device.

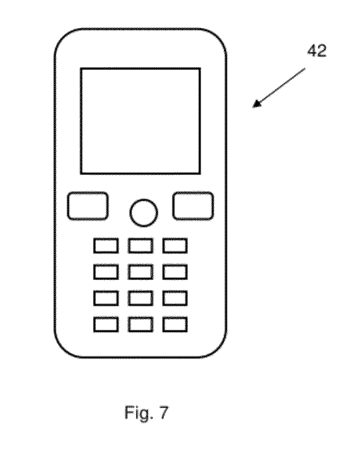

FIG. 7 shows a device 42, namely a mobile telephone, according to an embodiment of the invention. The device 42 comprises at least one switch 18 or system according to an embodiment of the invention.

It should be noted that the systems illustrated and described in this patent application may comprise one or more additional components. The systems may for example comprise an antenna switch or front end module to connect an antenna to any one of a plurality of amplifiers for example to switch in different frequency bands.

Further modifications of the invention within the scope of the claims would be apparent to a skilled person.

1. Switch arrangement that comprises a plunger member that is arranged to be displaced between a first position and a second position, wherein said plunger member is arranged to establish electrical contact in a first transmission line in said first position and to establish electrical contact in a second transmission line in a second position, whereby the displacement of said plunger member is arranged to break electrical contact with said first transmission line while said plunger member is being displaced from said first position into said second position, and to break electrical contact with said second transmission line while said plunger member is being displaced from said second position into said first position.

2. Switch arrangement according to claim 1, wherein said plunger member comprises an electrically conducting probe or an external antenna connector.

3. Switch arrangement according to claim 1, wherein said switch arrangement is a coaxial switch arrangement.

4. Switch arrangement according to claim 1, wherein said switch arrangement is a double pole double throw switch arrangement.

5. Switch arrangement according to claim 1, wherein said electrical contact in said first transmission line is arranged to be established at the same time as electrical contact in said second transmission line is arranged to be broken, and said electrical contact in said second transmission line is arranged to be established at the same time as electrical contact in said first transmission line is arranged to be broken.

6. Switch arrangement according to claim 1, wherein said plunger member is resiliently-loaded, e.g. spring loaded.

7. Switch arrangement according to claim 1, wherein said dielectric isolator is mounted on said plunger member or on said first or second transmission line.

8. System comprising an antenna, an antenna matching network, an amplifier of a radio frequency (RF) module and a matching circuit and a switch arrangement for selectively connecting said amplifier to test apparatus or another antenna via said matching circuit when in a first position, and to said antenna via said antenna matching network when it is in a second position, wherein the system comprises a switch arrangement according to claim 1.

9. System according to claim 8, further comprising additional dual matching circuitry.

10. System according to claim 8, wherein at least part of said switch arrangement is arranged as a module on a substrate that is arranged to be connected between said amplifier and said antenna.

11. System according to claim 10, wherein said substrate comprises dielectric material or ceramic material, such as low temperature co-fired ceramic (LTCC).

12. Device comprising a switch according to claim 1.

13. Device according to claim 12, wherein the device comprises a communication device such as a mobile telephone, media player, Personal Communications System (PCS) terminal, Personal Data Assistant (PDA), laptop computer, palmtop receiver, camera, television, radar, navigation device, or any appliance that includes a transducer designed to transmit and/or receive radio, television, telephone and/or radar signals.
